(19) United States
(12) Patent Application Publication
(10) Pub. No.: US 2022/0077547 A1
(43) Pub. Date: Mar. 10, 2022

(54) POUCH CELL

(71) Applicant: Hilti Aktiengesellschaft, Schaan (LI)

(72) Inventors: Nora MARTINY, Herrsching-Breitbrunn (DE); Matthias LEPIORZ, Chemnitz (DE); Bernd ZIEGLER, Schwabmuenchen (DE); Kathrin SAX, Scheuring (DE); Robert STANGER, Kaufbeuren (DE); Moses ENDER, Buchs (CH); Klaus HAUSER, Schwabmuenchen (DE)

(21) Appl. No.: 17/276,031

(22) PCT Filed: Oct. 10, 2019
(86) PCT No.: PCT/EP2019/077467

§ 371 Date: Mar. 12, 2021

(30) Foreign Application Priority Data
Oct. 17, 2018 (EP) 18200867.2

(51) Int. Cl. H01M 50/528; H01M 50/581

(52) U.S. Cl. CPC H01M 50/528; H01M 2220/30; H01M 2200/105; H01M 50/581

(57) ABSTRACT

A pouch cell having at least one connection electrode via which the pouch cell can be electrically contacted, wherein the pouch cell includes a current interrupter configured, by virtue of a thermally induced change in its geometric dimensioning, at least temporarily to interrupt drawing of current via the connection electrode. Preferably, the current interrupter includes a material having a negative coefficient of thermal expansion, wherein the thermally induced change in its geometric dimensioning is brought about by a change in a pouch cell temperature.

The present invention relates to a pouch cell having at least one connection electrode via which the pouch cell can be electrically contacted. Furthermore, the present invention relates to a rechargeable battery pack having a pouch cell having at least one connection electrode via which the pouch cell can be electrically contacted. Moreover, the present invention relates to an electrical hand-held power tool having a rechargeable battery pack having a pouch cell having at least one connection electrode via which the pouch cell can be electrically contacted.

### BACKGROUND

Pouch cells per se and as part of a rechargeable battery of the type mentioned in the introduction are known in principle from the prior art. The phenomenon of an increased pouch cell temperature during feeding of current and during drawing of current is likewise known from the prior art. The process of feeding current can also be referred to as charging or a charging process. The process of drawing current can also be referred to as discharging in the course of device supply.

If the pouch cell temperature exceeds a critical temperature threshold, an outer enclosure of the pouch cell can burst open—typically owing to so-called swelling. Swelling can also be referred to as expansion of the pouch cell.

### SUMMARY OF THE INVENTION

It is an object of the present invention to provide a pouch cell, a rechargeable battery pack having a pouch cell and also an electrical hand-held power tool having a rechargeable battery pack having a pouch cell which afford the basis of increased operational safety.

The invention is achieved by virtue of the fact that the pouch cell comprises a current interrupter configured, by virtue of a thermally induced change in its geometric dimensioning, at least temporarily to interrupt drawing of current via the connection electrode.

The invention includes the insight that rechargeable battery-operated hand-held power tools are becoming ever more powerful with ever greater performance and, for reasons of approval, the voltage of hand-held power tools at the present time is generally limited to a maximum of 60 V. In order nevertheless to be able to realize high powers, the current of a supply rechargeable battery must be increased. Pouch cells afford major advantages here on account of their significantly lower internal resistance by comparison with cylindrical cells. Pouch cells fundamentally enable significantly higher currents in conjunction with less heating of the cells. A disadvantage of pouch cells by comparison with cylindrical cells is that hitherto no intrinsic safety has been able to be incorporated.

In other words, the prior art does not disclose any satisfactory passive safety systems for pouch cells which prevent the outer enclosure from bursting open in the case of a disturbance (i.e. swelling of the outer enclosure of the pouch cell). It has been observed in this context that even when an outer enclosure has burst open, there is still a certain ionic conductivity and a flow of electrons at the pouch cells. Consequently, with a burst outer enclosure, further charging or overcharging of the pouch cell can occur, thereby causing further heating of the pouch cell.

The current interrupter provided according to the invention creates a basis for avoiding or at least reducing these disadvantages of the prior art. By virtue of a thermally induced change in the geometric dimensioning of the current interrupter, drawing of current via the connection electrode is at least temporarily interrupted, thereby preventing further charging or overcharging of the pouch cell. A rechargeable battery pack based on pouch cells can be particularly safe in operation owing to the current interrupter provided according to the invention.

In one particularly preferred configuration, the current interrupter comprises a material having a negative coefficient of thermal expansion. The thermally induced change in the geometric dimensioning of the current interrupter is preferably brought about by a change in a pouch cell temperature, wherein the current interrupter is preferably thermally coupled to the pouch cell. The current interrupter can be concomitantly thermally coupled to the pouch cell just temporarily.

In one particularly preferred configuration, the current interrupter is arranged at the connection electrode. A current interrupter can be provided at each connection electrode. It has proved to be advantageous if the current interrupter itself is part of the connection electrode.

In one particularly preferred configuration, the connection electrode comprises an inner portion and an outer portion. Preferably, the inner portion is surrounded by an outer enclosure of the pouch cell and/or the outer portion is situated outside said outer enclosure. The inner portion and the outer portion can be positionally fixed in relation to the outer enclosure and/or positionally fixed with respect to one another. The inner portion can be completely surrounded by the outer enclosure. At least sections and/or a small proportion of the outer portion can be surrounded by the outer enclosure. Preferably, the current interrupter is completely surrounded by the outer enclosure, particularly preferably independently of its state. Preferably, the inner portion and the outer portion are electrically conductive, for example with an electrical conductivity of greater than 1×10⁵ siemens per meter. Particularly preferably, the inner portion and the outer portion consist of or comprise metal. Particularly preferably, the pouch cell comprises an active layer that is thermally coupled to the current interrupter.

In a further preferred configuration, the current interrupter is arranged between the inner portion and the outer portion in the sense of a mechanical and/or electrical series connection. Geometric shortening of the current interrupter, in the case of a material having a negative coefficient of thermal expansion and with the pouch cell temperature rising, then advantageously results in a mechanical separation and/or electrical isolation between the inner portion and the outer portion. The current interrupter can be part of an electrical circuit into which the pouch cell itself is electrically integrated, preferably in series connection.

It has proved to be advantageous if the current interrupter is configured in such a way that a current interruption is brought about by thermal shrinkage of the material, particularly if the pouch cell temperature exceeds a predefined temperature threshold. The predefined temperature threshold can be 60 degrees Celsius, for example.

In a further preferred configuration, the material having a negative coefficient of thermal expansion comprises zirconium tungstate (ZrW₂O₈). In order to increase the electrical conductivity, the material can contain metal particles, such as nickel or copper, for example. Composite materials are known, for example on the basis of zirconium tungstate and nickel in nanoform, which have a negative coefficient of thermal expansion in conjunction with a comparatively high electrical conductivity. It has proved to be advantageous if the material has an electrical conductivity of greater than 1×10⁵ siemens per meter.

In a further preferred configuration, the current interrupter is configured to reversibly interrupt the connection electrode, i.e. the current interrupter permits a current flow through the connection electrode again when the pouch cell temperature falls below the predefined temperature threshold. Alternatively, the current interrupter can be configured, when the temperature threshold is exceeded for the first time, to permanently interrupt drawing of current via the connection electrode, for example by the current interrupter being mechanically torn away from the inner portion and/or from the outer portion of the electrode.

The invention is likewise achieved by way of a rechargeable battery pack having one or more pouch cells of the type described above. The invention is likewise achieved by way of an electrical hand-held power tool having a rechargeable battery pack of the type described above. The rechargeable battery pack of the system comprising hand-held power tool and rechargeable battery pack can advantageously be developed with reference to the features described above.

Further advantages can be found in the following description of figures. Various exemplary embodiments of the present invention are illustrated in the figures. The figures, the description and the claims contain numerous features in combination. A person skilled in the art will expediently also consider the features individually and combine them to form useful further combinations.

### BRIEF DESCRIPTION OF THE DRAWINGS

In the figures, components which are the same and components of the same type are denoted by the same reference signs. In the figures:

FIG. 1a shows a first preferred exemplary embodiment of a pouch cell according to the invention having a current interrupter;

FIG. 1b shows a schematic illustration of a hand-held power tool having a rechargeable battery pack and a pouch cell;

FIGS. 2A and 2B shows the pouch cell from FIG. 1a with the temperature threshold having been undershot (FIG. 2A) and with the temperature threshold having been exceeded (FIG. 2B);

FIG. 3 shows a second preferred exemplary embodiment of a pouch cell according to the invention with the temperature threshold having been undershot; and

FIG. 4 shows the exemplary embodiment from FIG. 3 with the temperature threshold having been exceeded.

### DETAILED DESCRIPTION

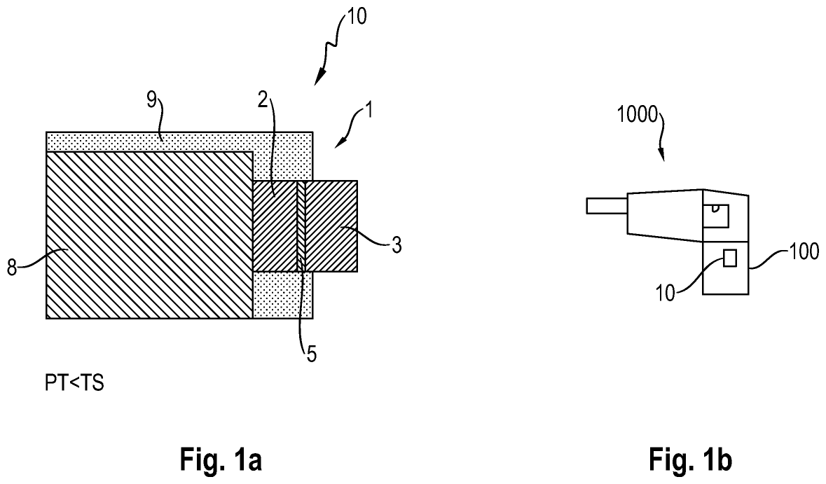

A first preferred exemplary embodiment of a pouch cell 10 according to the invention is illustrated in FIG. 1a. The pouch cell 10 has a connection electrode 1 via which the pouch cell 10 can be electrically contacted. To put it more precisely, the connection electrode 1 is electrically connected to an active layer 8 of the pouch cell 10. The active layer 8 is completely surrounded by an outer enclosure 9 of the pouch cell 10.

The connection electrode 1 comprises an inner portion 2 and an outer portion 3, wherein the inner portion 2 is completely surrounded by the outer enclosure 9 of the pouch cell 10 and the outer portion 3 is situated predominantly outside said outer enclosure 9.

The pouch cell 10 comprises a current interrupter 5 configured, by virtue of a thermally induced change in its geometric dimensioning, at least temporarily to interrupt drawing of current via the connection electrode 1. In the exemplary embodiment illustrated in the present case, the current interrupter 5 is part of the connection electrode 1, wherein the current interrupter 5 is situated between the inner portion 2 and the outer portion 3 in the sense of a mechanical and electrical series connection.

The inner portion 2 and the outer portion 3 are incorporated into the outer enclosure 9, for example by being welded therein, in each case in a manner positionally fixed in relation to the outer enclosure 9. Furthermore, the inner portion 2 and the outer portion 3 are arranged in a manner positionally fixed with respect to one another. This applies in particular to the sections of the inner portion 2 and of the outer portion 3 which are closest to one another. The term “positionally fixed” takes into account a certain inherent flexibility of the pouch cell 10.

In the exemplary embodiment illustrated in the present case, the current interrupter 5 comprises a material having a negative coefficient of thermal expansion, for example zirconium tungstate. Nickel components are incorporated in the material, such that besides a negative coefficient of thermal expansion, the material also has an electrical conductivity of greater than 1×10⁵ siemens per meter.

In FIG. 1a, a pouch cell temperature PT falls below a predefined temperature threshold TS, wherein the predefined temperature threshold is 60 degrees Celsius, for example. In this state, the inner portion 2 and the outer portion 3 are electrically contacted via the current interrupter 5, such that the pouch cell 10 can be charged or discharged.

FIG. 1b schematically illustrates an electrical hand-held power tool 1000, which is supplied via a rechargeable battery pack 100, wherein the rechargeable battery pack is equipped with at least one pouch cell 10.

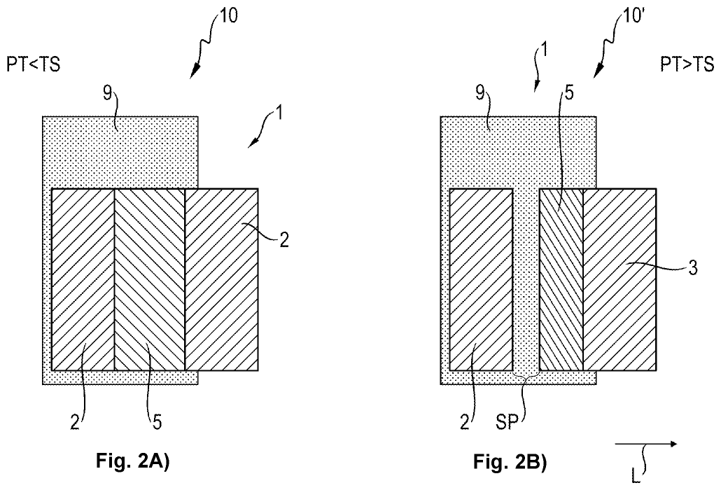

FIG. 2A shows an excerpt from the pouch cell from FIG. 1a, wherein, as in FIG. 1a, the pouch cell temperature PT falls below the predefined temperature threshold TS. Consequently, the inner portion 2 and the outer portion 3 are electrically contacted via the current interrupter 5.

A current interruption will now be explained in more specific detail with reference to FIG. 2B. As already mentioned, the current interrupter 5 comprises a material having a negative coefficient of thermal expansion. A change in the geometric dimensioning of the current interrupter 5 is brought about by a change in the pouch cell temperature PT. By virtue of the fact that the inner portion 2 consists of metal, the inner portion 2 and the current interrupter 5 are thermally coupled, such that the current interrupter 5 experiences an increase in temperature of the active layer 8 via the inner portion 2.

In the exemplary embodiment illustrated, the current interruption is brought about by thermal shrinkage of the material if the pouch cell temperature PT exceeds a predefined temperature threshold TS. As is evident from FIG. 2B), the change in the geometric dimensioning of the material is a shortening of the material of the current interrupter 5 in the longitudinal direction L. Since the inner portion 2 and the outer portion 3 are positionally fixed in relation to the outer enclosure 9 and positionally fixed with respect to one another, shrinkage of the current interrupter 5 in the longitudinal direction L—indicated here by a gap SP that is formed—brings about electrical isolation of the outer portion 3 from the inner portion 2. Consequently, the pouch cell 10′ in an elevated temperature state can neither continue to be charged nor be discharged.

In the present case, the current interrupter 5 is configured to reversibly interrupt drawing of current via the connection electrode 1. If the pouch cell temperature PT falls below the predefined temperature threshold TS, a current flow is possible once again, cf. FIG. 2A.

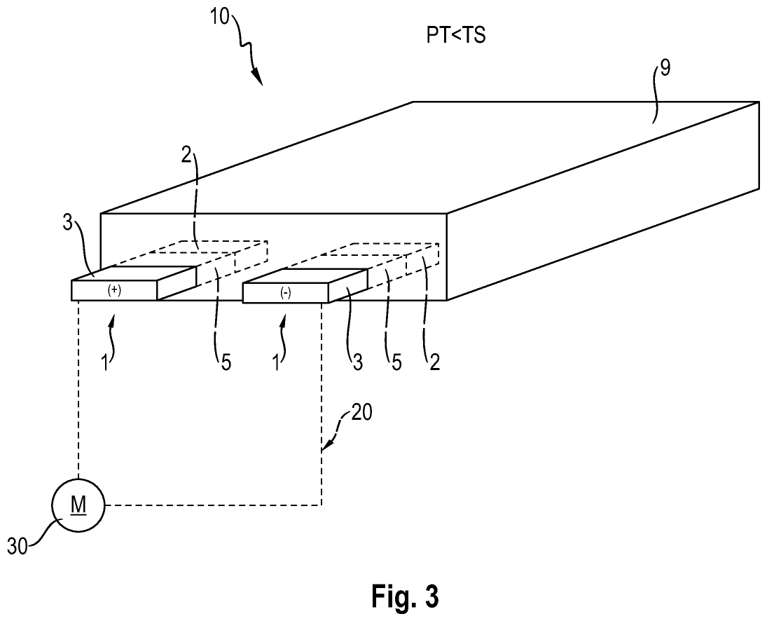

FIG. 3 shows a second preferred exemplary embodiment of a pouch cell 10 according to the invention in a perspective illustration. The pouch cell 10 comprises two connection electrodes 1 in the form of a positive electrode and a negative electrode, via which the pouch cell 10 can be electrically contacted in each case.

The connection electrodes 1 comprise in each case an inner portion 2 and in each case an outer portion 3, wherein the inner portions 2 are completely surrounded by the outer enclosure 9 of the pouch cell 10 (dashed illustration). The respective outer portions 3 lie predominantly outside said outer enclosure 9.

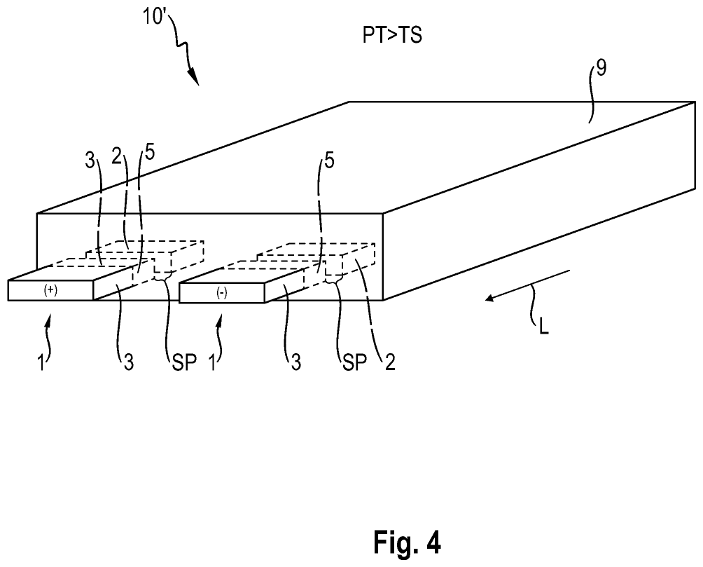

Each of the connection electrodes 1 has a current interrupter 5 comprising a material having a negative coefficient of thermal expansion, such that, if the pouch cell temperature PT exceeds a predefined temperature threshold TS (cf. FIG. 4), a current interruption is brought about by thermal shrinkage of the material.

As can be gathered from FIG. 3, the current interrupters 5 are part of an electrical circuit 20 into which the pouch cell 10 itself is integrated electrically in series connection. The electrical circuit serves for the electrical supply of an electric motor 30 of a hand-held power tool 1000 (see FIG. 1b).

A current interruption will now be explained in more specific detail with reference to FIG. 4. As already mentioned, the current interrupters 5 comprise a material having a negative coefficient of thermal expansion. A change in the geometric dimensioning of the current interrupter 5 is brought about by a change in the pouch cell temperature PT.

As is evident from FIG. 4, the change in the geometric dimensioning of the material is a shortening of the material of the current interrupters 5 in the longitudinal direction L. Since the inner portion 2 and the outer portion 3 are in each case positionally fixed in relation to the outer enclosure 9 and in each case positionally fixed with respect to one another, shrinkage of the current interrupters 5 in the longitudinal direction L—indicated here by a gap SP that is formed in each case—brings about electrical isolation of the respective outer portion 3 from the respective inner portion 2. Consequently, the pouch cell 10′ in an elevated temperature state can neither continue to be charged nor be discharged.

### LIST OF REFERENCE SIGNS

1 Connection electrode
2 Inner portion
3 Outer portion
5 Current interrupter
8 Active layer
9 Outer enclosure
10 Pouch cell (normal temperature)
10′ Pouch cell (temperature threshold exceeded)
20 Electrical circuit
30 Electric motor
100 Rechargeable battery pack
1000 Hand-held power tool
L Longitudinal direction
PT Pouch cell temperature
SP Gap
TS Temperature threshold

What is claimed is:

1-12. (canceled)

13. A pouch cell comprising:
at least one connection electrode, the pouch cell being electrically contactable via the at least one connection electrode;
a current interrupter configured, by virtue of a thermally induced change in a geometric dimensioning of the current interrupter, at least temporarily to interrupt drawing of current via the connection electrode.

14. The pouch cell as recited in claim 13 wherein the current interrupter includes a material having a negative coefficient of thermal expansion and the thermally induced change in the geometric dimensioning is brought about by a change in a pouch cell temperature.

15. The pouch cell as recited in claim 13 wherein the current interrupter is arranged at the connection electrode or is part of the connection electrode.

16. The pouch cell as recited in claim 13 wherein the current interrupter is configured in such a way that a current interruption is brought about by thermal shrinkage of a material of the current interrupter.

17. The pouch cell as recited in claim 16 wherein the current interruption occurs if a pouch cell temperature exceeds a predefined temperature threshold.

18. The pouch cell as recited in claim 13 wherein the connection electrode includes an inner portion and an outer portion, wherein the inner portion surrounded by an outer enclosure of the pouch cell and the outer portion, at least in sections, is situated outside the outer enclosure.

19. The pouch cell as recited in claim 18 wherein the inner portion is completely surrounded by the outer enclosure.

20. The pouch cell as recited in claim 18 wherein the inner portion and the outer portion are positionally fixed in relation to the outer enclosure or positionally fixed with respect to one another.

21. The pouch cell as recited in claim 13 wherein the current interrupter is part of an electrical circuit into which the pouch cell itself is electrically integrated.

22. The pouch cell as recited in claim 13 wherein the current interrupter is in series connection in the electrical circuit.

23. The pouch cell as recited in claim 14 wherein the material includes zirconium tungstate.

24. The pouch cell as recited in claim 14 wherein the material has an electrical conductivity of greater than 1×10\hat{ }5 siemens per meter.

25. The pouch cell as recited in claim 13 wherein the current interrupter is configured to reversibly interrupt drawing of current via the connection electrode.

26. A rechargeable battery pack comprising the pouch cell as recited in claim 13

27. An electrical hand-held power tool comprising the rechargeable battery pack as recited in claim 26.
